(19) United States
(12) Patent Application Publication
(10) Pub. No.: US 2026/0268631 A1
(43) Pub. Date: Sep. 10, 2026

(54) SYSTEM FOR SENSOR FUSION IN AUTONOMOUS DRIVING BY USING ARTIFICIAL INTELLIGENCE AND METHOD IMPLEMENTING THE SAME

(71) Applicants: Hyundai Motor Company, Seoul (KR); Kia Corporation, Seoul (KR)

(72) Inventors: So Yeon JEON, Hwaseong-Si (KR); Yun Sung NOH, Hwaseong-Si (KR)

(21) Appl. No.: 19/326,182

(22) Filed: Sep. 11, 2025

(30) Foreign Application Priority Data
Mar. 5, 2025 (KR) 10-2025-0028507

(51) Int. Cl. G06V 10/25; B60W 60/00; G06T 7/11; G06T 7/149; G06T 7/73; G06V 10/24; G06V 10/74; G06V 10/75; G06V 10/80; G06V 20/58

(52) U.S. Cl. CPC G06V 10/25; B60W 60/001; G06T 7/11; G06T 7/149; G06T 7/73; G06V 10/24; G06V 10/7553; G06V 10/761; G06V 10/803; G06V 10/806; G06V 20/58; B60W 2420/403; B60W 2556/35; G06T 2207/30252; G06V 2201/07

(57) ABSTRACT

An apparatus of a vehicle may comprise a processor and a memory storing at least one instruction that, when executed by the processor communicating with the memory, is configured to cause the apparatus to set at least one reference sensor among a plurality of sensors of the vehicle and set at least one second sensor among the plurality of sensors, obtain, from the at least one reference sensor and the at least one second sensor, shape information and heading angle information, generate, based on the shape information and the heading angle information, a reference predicted bounding box (P-Box) and at least one second P-Box, generate a fusion P-Box, output a signal, and control, based on the signal, autonomous driving of the vehicle.

### CROSS-REFERENCE TO RELATED APPLICATION

This application claims the benefit of priority to Korean Patent Application No. 10-2025-0028507, filed with the Korean Intellectual Property Office on Mar. 5, 2025, the entire contents of which are incorporated herein by reference.

### TECHNICAL FIELD

The present disclosure relates to an autonomous driving sensor fusion system and method using artificial intelligence (AI), and more specifically, to an autonomous driving sensor fusion system and method using AI that synthesizes a result of recognizing a track object existing in a surrounding environment from data input from two or more autonomous driving sensors, while enabling optimal sensor fusion using four vertices that recognize the object.

### BACKGROUND

With the development and commercialization of autonomous vehicles, the use of various sensors and artificial intelligence (AI) technologies to support autonomous driving functions of vehicles is increasing. For example, research is ongoing into what object exists in front of a moving vehicle, what the distance is between the object and the vehicle, and what algorithm the vehicle should use to respond to specific situations to ensure safety.

Accordingly, vehicle sensor technology is becoming more advanced, and high-performance sensors such as light detection and ranging (LiDAR) that recognizes a surrounding environment using a laser beam, radio detection and ranging (RADAR) that uses radio waves, ultrasonic sensors, fisheye cameras capable of shooting 360-degree images, multifocal lenses, and a global positioning system (GPS) are being installed in a vehicle.

As above, by integrating measurement results obtained from a plurality of sensors, it has become possible to implement a super sensor vehicle. In self-driving (autonomous driving), concept of a super sensor refers to a technology that seeks to more accurately recognize the surrounding environment by combining measurements from various sensors rather than relying on individual sensors for convenience and safety of driving. With the addition of information and communications technology (ICT) and cloud technology, sensors and AI algorithms required for autonomous driving are becoming more sophisticated than ever before, not only for a single vehicle, but also for a fleet of vehicles, remotely accumulating data and training AI servers and databases to increase reliability of vehicle sensor determination.

Among these, autonomous driving sensors such as radar and LiDAR, which may be used to recognize external environments, emit radio waves or lasers and measure the time it takes for reflection and intensity of the reflected radio waves or lasers, thereby identifying various objects present on the road during autonomous driving.

However, in order to integrate the sensors mentioned above, a process of fusing the results recognized by each autonomous driving sensor is required, and how to optimally fuse the sensor recognition results is considered.

### SUMMARY

The present disclosure attempts to provide a sensor fusion system and method for autonomous driving using artificial intelligence (AI). More specifically, a main technical task is to implement an autonomous driving sensor fusion system and method using AI that synthesizes results of recognizing track objects existing in a surrounding environment from data input from two or more autonomous driving sensors, while enabling optimal sensor fusion using four vertices that recognize the objects.

Of course, the technical problems of the present disclosure are not limited to the technical problems mentioned above, and other technical problems not explicitly mentioned will be clearly understood by those skilled in the art from the detailed description of the present disclosure and the attached drawings.

In order to solve all or at least part of the above-described technical problems, the present disclosure may be implemented in various examples as follows.

According to the present disclosure, an apparatus of a vehicle, the apparatus may comprise, a processor, and a memory storing at least one instruction that, when executed by the processor communicating with the memory, is configured to cause the apparatus to, set at least one reference sensor among a plurality of sensors of the vehicle and set at least one second sensor among the plurality of sensors, and obtain, from the at least one reference sensor and the at least one second sensor, shape information and heading angle information, wherein the shape information may comprise at least four vertices position information of an object existing in a surrounding environment of the vehicle, and wherein the object is recognized based on an artificial intelligent model by fusing data input from at least two sensors of the plurality of sensors, generate, based on the shape information and the heading angle information from the at least one reference sensor, a reference predicted bounding box (P-Box), generate, based on the shape information and the heading angle information from the at least one second sensor, at least one second P-Box, select an alignment target P-Box among the at least one second P-BOX, wherein the alignment target P-Box is selected based on a highest similarity to the shape information of the reference P-Box and the heading angle information of the reference P-Box, based on four vertices position information of the reference P-Box, adjust four vertices position information of the alignment target P-Box, based on the adjusted four vertices position information of the alignment target P-Box, generate a fusion P-Box by fusing the alignment target P-Box and the reference P-Box, output a signal indicating an object recognized based on the fusion P-Box, and control, based on the signal, autonomous driving of the vehicle.

The apparatus, wherein the at least one instruction, when executed by the processor communicating with the memory, is configured to cause the apparatus to obtain coordinate values of four vertices of the fusion P-Box by, determining virtual vertices, based on a first shape ratio applied to the reference P-Box and a second shape ratio applied to the alignment target P-Box on four virtual connecting lines, wherein the four virtual connecting lines connect four vertices of the alignment target P-Box with the adjusted four vertices position information and four vertices of the reference P-Box in an alignment order.

The apparatus, wherein a sum of the first shape ratio and the second shape ratio is equal to one. The apparatus, wherein the at least one instruction, when executed by the processor communicating with the memory, is configured to cause the apparatus to adjust a quadrangular shape of the fusion P-Box to a fitting rectangular shape, wherein the fitting rectangular shape may comprise at least four vertices and four sides. The apparatus, wherein the at least one instruction, when executed by the processor communicating with the memory, is configured to cause the apparatus to adjust the quadrangular shape of the fusion P-Box by, setting a reference side among at least four sides forming the fusion P-Box, wherein the reference side is a side closest to the plurality of sensors and unaffected by occlusion, determining a width of the reference side as an adjusted width of the fitting rectangular shape, determining an adjusted length of the fitting rectangular shape by connecting a first center point of the reference side with a second center point of a second side positioned opposite to the reference side, and determining a vector perpendicular to the reference side and directed from the reference side toward the second side as an adjusted heading of the fitting rectangular shape.

The apparatus, wherein the at least one instruction, when executed by the processor communicating with the memory, is configured to cause the apparatus to, based on track class information corresponding to the fusion P-Box, readjust an adjusted length of the fitting rectangular shape and an adjusted width of the fitting rectangular shape. The apparatus, wherein the at least one instruction, when executed by the processor communicating with the memory, is configured to cause the apparatus to readjust the adjusted length of the fitting rectangular shape and the adjusted width of the fitting rectangular shape by, determining, based on the track class information, minimum and maximum values of length and width of the fitting rectangular shape, and determining the adjusted length and the adjusted width within a range between the minimum and maximum values of length and width of the fitting rectangular shape.

The apparatus, wherein the at least one instruction, when executed by the processor communicating with the memory, is configured to cause the apparatus to, set a reference vertex, wherein the reference vertex is a vertex with a highest reliability among at least four vertices of the fusion P-Box, and based on the reference vertex, the readjusted length of the fitting rectangular shape, and the readjusted width of the fitting rectangular shape, inversely adjust the track class information. The apparatus, wherein the at least one instruction, when executed by the processor communicating with the memory, is configured to cause the apparatus to readjust, based on a track absolute velocity, the adjusted heading of the fitting rectangular shape, wherein the track absolute velocity is an absolute velocity of an object recognized based on the fusion P-Box and adjusted based on the inversely adjusted track class information.

The apparatus, wherein the at least one instruction, when executed by the processor communicating with the memory, is configured to cause the apparatus to readjust the adjusted heading of the fitting rectangular shape by, identifying four heading candidates based on four sides associated with the inversely adjusted track class information, and selecting, among the identified four heading candidates, a heading candidate that is most closely aligned with the absolute velocity, as a readjusted heading vector associated with the inversely adjusted track class information.

According to the present disclosure, a method performed by an apparatus of a vehicle, the method may comprise, setting at least one reference sensor among a plurality of sensors of the vehicle and setting at least one second sensor among the plurality of sensors, obtaining, from the at least one reference sensor and the at least one second sensor, shape information and heading angle information, wherein the shape information may comprise at least four vertices position information of an object in a surrounding environment of the vehicle, wherein the object is recognized based on an artificial intelligent model by fusing data input from at least two sensors of the plurality of sensors, generating, based on the shape information and the heading angle information from the at least one reference sensor, a reference predicted bounding box (P-Box), generating, based on the shape information and the heading angle information from the at least one second sensor, at least one second P-Box, selecting an alignment target P-Box among the at least one second P-Box, wherein the alignment target P-Box is selected based on a highest similarity to the shape information and the heading angle information of the reference P-Box, based on four vertices position information of the reference P-Box, adjusting the four vertices position information of the alignment target P-Box, based on the adjusting of the four vertex position information of the alignment target P-Box, generating a fusion P-Box by fusing the alignment target P-Box and the reference P-Box, outputting a signal indicating an object recognized based on the fusion P-Box, and controlling, based on the signal, autonomous driving of the vehicle. The method, wherein the adjusting of the four vertices position information may comprise, obtaining coordinate values of four vertices of the fusion P-Box by determining virtual vertices, based on a first shape ratio applied to the reference P-Box and a second shape ratio applied to the alignment target P-Box on four virtual connecting lines, wherein the four virtual connecting lines connect four vertices of the alignment target P-Box with the adjusted four vertices position information and four vertices of the reference P-Box in an alignment order.

The method, wherein a sum of the first shape ratio and the second shape ratio is equal to one. The method may further comprise adjusting a quadrangular shape of the fusion P-Box to a fitting rectangular shape, wherein the fitting rectangular shape may comprise at least four vertices and four sides. The method, wherein the adjusting of the quadrangular shape of the fusion P-Box may comprise, setting a reference side among at least four sides forming the fusion P-Box, wherein the reference side is a side closest to the plurality of sensors and unaffected by occlusion, determining a width of the reference side as an adjusted width of the fitting rectangular shape, determining an adjusted length of the fitting rectangular shape by connecting a first center point of the reference side with a second center point of a second side positioned opposite to the reference side, and determining a vector perpendicular to the reference side and directed from the reference side toward the second side as an adjusted heading of the fitting rectangular shape.

The method may further comprise, based on track class information corresponding to the fusion P-Box, readjusting an adjusted length of the fitting rectangular shape and an adjusted width of the fitting rectangular shape. The method, wherein the readjusting of the adjusted length of the fitting rectangular shape and the adjusted width of the fitting rectangular shape may comprise, determining, based on the track class information, minimum and maximum values of length and width of the fitting rectangular shape, and determining the adjusted length and the adjusted width within a range between the minimum and maximum values of length and width.

According to the present disclosure, a vehicle may comprise, a first sensor, a second sensor, a driving control circuit configured to control autonomous driving of the vehicle, a processor, and a memory storing at least one instruction that, when executed by the processor communicating with the memory, is configured to cause the vehicle to, obtain, from the first sensor and the second sensor, shape information and heading angle information for an object in a surrounding environment of the vehicle, wherein the shape information may comprise at least four vertices positions of the object, based on the shape information and the heading angle information from the first sensor, generate a reference predicted bounding box (P-Box), based on the shape information and the heading angle information from the second sensor, generate at least one second P-Box, select, based on similarity to the reference P-Box, an alignment target P-Box from among the at least one second P-Box, based on vertex positions of the reference P-Box, adjust vertex positions of the alignment target P-Box, based on the reference P-Box and the alignment target P-Box with the adjusted vertex positions, generate a fusion P-Box, generate a fitting shape corresponding to the object in the surrounding environment of the vehicle by refining the fusion P-Box based on at least one of a size, heading of the fusion P-Box, or object class information, output a signal indicating the fitting shape, and control, via the driving control circuit and based on the signal, autonomous driving of the vehicle.

The vehicle, wherein the at least one instruction, when executed by the processor communicating with the memory, is configured to cause the vehicle to determine each vertex of the fusion P-Box by selecting a point between a corresponding vertex of the reference P-Box and a corresponding vertex of the alignment target P-Box, based on a weight assigned to each of the reference P-Box and the alignment target P-Box.

The vehicle, wherein the at least one instruction, when executed by the processor communicating with the memory, is configured to cause the vehicle to determine a heading of the fitting shape by, identifying, as a reference side, a side of the fusion P-Box that is closest to the first and second sensors and least affected by occlusion, identifying, as an opposite side, a side of the fusion P-Box positioned opposite to the reference side, and determining the heading as a vector perpendicular to the reference side and extending from the reference side toward the opposite side.

For example, by adopting a method that derives object attributes inversely using the four vertices of the box instead of deriving an AI prediction box based on object attributes, it may be possible to significantly reduce AI computation load and prevent errors in computation results in a case of addressing the aforementioned error scenarios.

Furthermore, various effects in addition to effects described above from the present disclosure by those skilled in the art are provided through the detailed description of the present disclosure and the attached drawings.

### BRIEF DESCRIPTION OF THE DRAWINGS

FIG. 1 shows an example overall system for automatically recognizing objects and controlling a vehicle for purposes such as autonomous driving.

FIG. 2 shows an example overall algorithm for recognizing an object by an AI module by fusing measurement results of two or more autonomous driving sensors.

FIG. 3 shows an example process for correcting a length and a width based on a track class.

FIG. 4 shows an example process for finally determining a heading vector of an object corresponding to a track class based on absolute velocity.

FIG. 5 shows an example of a method of fusing shape information and heading information of an object recognized by two or more autonomous driving sensors.

FIG. 6 shows an example process of generating a fused P-Box according to a predetermined weight assigned to two or more autonomous driving sensors.

FIG. 7 shows an example fitting rectangle derived from information obtained from two or more autonomous driving sensors, and displaying a corrected length, a corrected width, and corrected heading corresponding thereto.

FIG. 8 shows an example computing system for autonomous vehicle control and object recognition computation.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. Furthermore, in describing examples of the present disclosure, when it is determined that detailed descriptions of related well-known configurations or functions interfere with understanding of the examples of the present disclosure, the detailed descriptions thereof will be omitted.

In describing constituent elements according to various examples of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification. For example, in the present disclosure, the term ‘object’ essentially holds same meaning as ‘entity,’ and the expressions ‘object’ and ‘entity’ will be interchangeably used throughout the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of AI model based sensor fusion for object shape and heading estimation) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of AI model based sensor fusion for object shape and heading estimation) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of AI model based sensor fusion for object shape and heading estimation) described herein.

Minimum risk maneuver (MRM) operation(s) may also be controlled, for example, based on one or more features (e.g., feature of AI model based sensor fusion for object shape and heading estimation) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of AI model based sensor fusion for object shape and heading estimation) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of AI model based sensor fusion for object shape and heading estimation) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of AI model based sensor fusion for object shape and heading estimation) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

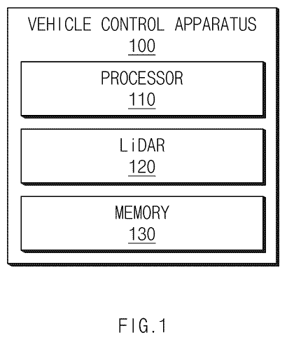

FIG. 1 shows an example overall system for automatically recognizing objects and controlling a vehicle for purposes such as autonomous driving.

Referring to FIG. 1, a vehicle control apparatus 100 according to an example of the present disclosure may be implemented inside or outside a vehicle, and some of the components included in the vehicle control apparatus 100 may be implemented inside or outside the vehicle. In the instant case, the vehicle control apparatus 100 may be integrally formed with internal control units of the vehicle, or may be implemented as a separate device to be connected to control units of the vehicle by a separate connection means. For example, the vehicle control apparatus 100 may further include components not shown in FIG. 1.

The vehicle control apparatus 100 according to an example may include a processor 110, a LiDAR 120, and a memory 130. The processor 110, the lidar 120, or the memory 130 may be electronically and/or operably coupled with each other by an electronic component including a communication bus.

Hereinafter, hardware components being operatively coupled may include a direct connection, and/or an indirect connection established between the components, wired, and/or wireless, such that a second component is controlled by a first component among the components.

Although they are illustrated in different blocks, the examples are not limited thereto. For example, some of the hardware components in FIG. 1 may be included in a single integrated circuit including a system on a chip (SoC). A type and/or number of hardware components included in the vehicle control apparatus 100 is not limited to that shown in FIG. 1. For example, the vehicle control apparatus 100 may include some of the components illustrated in FIG. 1.

The vehicle control apparatus 100 according to an example may include hardware for processing data based on one or more instructions. For example, the hardware for processing data may include a processor 110. For example, the hardware for processing data may include an arithmetic and logic unit (ALU), a floating point unit (FPU), a field programmable gate array (FPGA), a central processing unit (CPU), and/or an application processor (AP). The processor 110 may be configured to have a single-core processor structure, or a multi-core processor structure including dual core, quad core, hexa core, or octa core (e.g., depending on the computational complexity of perception models, route planning, or control logic, etc.).

According to another example, the processor 110 may be configured to include at least one of a graphic processing unit (GPU), a neural processing unit (NPU), or any combination thereof. For example, the GPU may be referred to as a visual processing unit (VPU). For example, the NPU may be referred to as a neural network processing unit.

The vehicle control apparatus 100 according to an example may include a depth sensor for detecting external objects. For example, the depth sensor for detecting external objects may include at least one of a time of flight (ToF) sensor, a light detection and ranging (LiDAR) 120, a structured light sensor, an ultrasonic sensor, an infrared sensor, a radio detection and ranging (RADAR), an optical distance sensor, or any combination thereof (e.g., combining LiDAR and RADAR to improve robustness in low-visibility conditions, etc.). Hereinafter, for better understanding and ease of description, a description will focus on the LiDAR.

The vehicle control apparatus 100 according to an example may include a LiDAR120 that acquires a plurality of points based on a pulse laser signal. For example, the LiDAR120 may acquire data sets that identify objects surrounding the vehicle control apparatus 100 (or a vehicle including the vehicle control apparatus 100). For example, the LiDAR120 may identify at least one of a position, a moving direction, a velocity, or any combination thereof of a surrounding object based on the pulse laser signal emitted from the LiDAR120 being reflected back by the surrounding object (e.g., a nearby vehicle, a pedestrian, a tree, or a building, etc.).

For example, the LiDAR may obtain data sets representing external objects in a space formed by an x-axis, a y-axis, and a z-axis based on the pulse laser signal reflected from the surrounding object. For example, the LiDAR120 may acquire data sets including a plurality of points in the space formed by the x-axis, the y-axis, and the z-axis based on receiving the pulse laser signal every designated period (e.g., every 100 milliseconds, every sensor frame, or at a refresh rate of 10 Hz, etc.). For example, the points may include points representing external objects within a 3D virtual coordinate system. The 3D virtual coordinate system may include at least one of a vehicle coordinate system, a lidar coordinate system, or any combination thereof. However, an example of the 3D virtual coordinate system is not limited to those described above (e.g., it may include a world coordinate system or a map-based coordinate system, etc.).

The memory 130 of the vehicle control apparatus 100 according to an example may include a hardware component for storing data and/or instructions input to and/or output from the processor 110 of the vehicle control apparatus 100. For example, the memory 130 may include a volatile memory including a random-access memory (RAM), and/or a nonvolatile memory including a read-only memory (ROM).

For example, the volatile memory may include at least one of a dynamic RAM (DRAM), a static RAM (SRAM), a Cache RAM, a pseudo SRAM (PSRAM), or any combination thereof. For example, the nonvolatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof (e.g., depending on cost, size, write endurance, or access speed, etc.).

Within the memory 130 of the vehicle control apparatus 100, one or more instructions (or commands) indicating computations and/or actions to be performed by the processor 110 of the vehicle control apparatus 100 based on data may be stored. A set of one or more instructions may be referred to as a program, a firmware, an operating system, a process, a routine, a sub-routine, and/or an application (e.g., an object detector, a SLAM module, or a LiDAR segmentation engine, etc.).

Hereinafter, a point that an application is installed in a vehicle control apparatus 100 may indicate that one or more instructions provided in a form of an application are stored in the memory 130, and that one or more applications are stored in a format that is executable by the processor 110 of the vehicle control apparatus 100 (e.g., a file having an extension designated by an operating system of the vehicle control apparatus 100) (e.g., a binary executable file, or a compiled library, etc.).

For example, the memory 130 may include a first neural network model for detecting an object. For example, the memory 130 may include a second neural network model for outputting types of the points acquired by the lidar 120 and/or scores of the points (e.g., object class scores or distance likelihoods, etc.).

In an example, the processor 110 may be configured to obtain at least one of a first virtual box representing a target object, a first class representing a type of the target object, or any combination thereof, based on the points acquired through the LiDAR120 and the first neural network model stored in the memory 130.

For example, the processor 110 may be configured to obtain at least one of a first virtual box representing a target object, a first class representing a type of the target object, or any combination thereof, based on inputting a plurality of points into the first neural network model. For example, the first neural network model may include an object detection model (e.g., a 3D bounding box detector or a center-based detection network, etc.). For example, the target object may include an external object positioned within a designated distance from the vehicle control apparatus 100 (or a vehicle including the vehicle control apparatus 100) (e.g., within a 50-meter range in the forward direction, etc.). For example, the target object may include an object that is identified by the vehicle control apparatus 100 and is continuously tracked. For example, the type of the target object may include multiple types for classifying the target object. For example, the type of the target object may include at least one of a first type representing a ground, a second type representing a type that is different from the ground, or any combination thereof. However, the type of the target object is not limited to what was described above. For example, the type of the target object may include at least one of a third type representing a person, a fourth type representing a vehicle, or any combination thereof (e.g., a bicycle, a traffic cone, a tunnel wall, or a construction sign, etc.), but the present disclosure is not limited thereto.

In an example, the processor 110 may be configured to obtain, based on the points and the second neural network model, at least one of first partial points corresponding to at least a portion of the target object among the points, a second class identified through the first partial points and indicating the type of the target object, or any combination thereof. For example, the second neural network model may include a segmentation model (e.g., a range-view CNN, a point-based classifier, or a sparse voxel network, etc.).

For example, the second neural network model may include a neural network model for obtaining types of multiple points and scores of the points (e.g., softmax outputs, probability heatmaps, or class activation scores, etc.).

For example, the processor 110 may be configured to obtain first partial points corresponding to at least a portion of the target object among the points based on inputting the points into the second neural network model. For example, the processor 110 may be configured to identify the types of the points based on inputting the points into the second neural network model. For example, the processor 110 may be configured to obtain first partial points corresponding to at least a portion of the target object from among the points based on the type of each of the points (e.g., classifying some points as belonging to a vehicle, pedestrian, or roadside object, etc.).

In an example, the processor 110 may be configured to perform a first designated algorithm on the points. For example, the processor 110 may be configured to perform the first designated algorithm for classifying a type of each of the points for the points, for example, within the LiDAR data frame. For example, the processor 110 may be configured to classify second partial points corresponding to a designated type among the points. For example, the designated type may include a type representing the ground (e.g., pavement, crosswalks, or flat surfaces, etc.).

For example, the processor 110 may be configured to classify the second partial points corresponding to a designated type based on performing the first designated algorithm on the points and obtain (or identify) the first partial points by excluding the second partial points from among the points (e.g., separating above-ground structures from terrain, etc.).

For example, the processor 110 may be configured to obtain at least one of a partial class for obtaining a second class, a score for each of the points, or any combination thereof, based on inputting the points into the second neural network model. For example, the processor 110 may be configured to obtain a partial class and a score for each of the points based on inputting the points into the second neural network model. For example, the partial class may contain a classification of each of the points into an arbitrary type (e.g., tree, vehicle, pedestrian, or unknown, etc.).

For example, the processor 110 may be configured to fuse the partial class, the scores of each of the points, and the second partial points (e.g., for joint feature enhancement or confidence weighting, etc.). For example, the processor 110 may be configured to perform clustering based on fusing the partial class, the scores of each of the points, and the second partial points. For example, the clustering may involve grouping first partial points that correspond to at least a portion of the target object (e.g., to generate an instance-level region for bounding box generation, etc.).

For example, the processor 110 may be configured to obtain a point cloud for generating a second virtual box based on the first partial points. For example, the processor 110 may be configured to obtain the point cloud based on grouping the first partial points (e.g., using spatial proximity, density thresholding, or Density-Based Spatial Clustering of Applications with Noise (DBSCAN), etc.).

For example, the processor 110 may be configured to generate a second virtual box, different from the first virtual box and for representing the target object, based on the point cloud. For example, the second virtual box may include a box that includes at least some of the first partial points (e.g., tightly fitted to the object's spatial extent, etc.).

For example, the processor 110 may be configured to identify a heading direction indicating a traveling direction of the target object based on at least one of the first partial points, the point cloud, or any combination thereof (e.g., using temporal point shifts or bounding box orientation, etc.).

For example, the processor 110 may be configured to identify a position of a second virtual box in a virtual coordinate system based on at least one of the first partial points, the point cloud, or any combination thereof (e.g., by computing the centroid of the clustered points, using a bounding box anchor, or referencing vehicle-relative coordinates, etc.). For example, the processor 110 may be configured to identify a size of the second virtual box based on at least one of the first partial points, the point cloud, or any combination thereof (e.g., by estimating width, height, and depth based on point dispersion or statistical spread, etc.).

For example, the processor 110 may be configured to identify a second class based on at least one of the first partial points, the point cloud, or any combination thereof (e.g., classifying as car, pedestrian, traffic cone, or unknown, etc.). For example, the processor 110 may be configured to identify at least one of the heading direction indicating the traveling direction of the target object, a position of the second virtual box in the virtual coordinate system, the size of the second virtual box, the second class, or any combination thereof, based on at least one of the first partial points, the point cloud, or any combination thereof (e.g., to aid in trajectory prediction, collision risk estimation, or classification confidence, etc.).

For example, the processor 110 may be configured to identify the heading direction of the bounding box based on at least one of the first virtual box, the first class, the heading direction of the second virtual box, the position of the second virtual box, the size of the second virtual box, the second class, or any combination thereof (e.g., by tracking box orientation over time, using direction vectors, or aligning with lane markings, etc.). For example, the processor 110 may be configured to identify a position of the bounding box in the virtual coordinate system based on at least one of the first virtual box, the first class, the heading direction of the second virtual box, the position of the second virtual box, the size of the second virtual box, the second class, or any combination thereof (e.g., using Kalman filtering, relative coordinate mapping, or GPS reference data, etc.).

For example, the processor 110 may be configured to obtain a third class indicating a type of the target object corresponding to the bounding box based on at least one of the first virtual box, the first class, the heading direction of the second virtual box, the position of the second virtual box, the size of the second virtual box, the second class, or any combination thereof (e.g., refining classification using fusion from multiple frames, object hierarchy rules, or semantic context, etc.). For example, the processor 110 may be configured to obtain at least one of the heading direction of the bounding box, the position of the bounding box in the virtual coordinate system, the third class indicating the type of the target object corresponding to the bounding box, or a combination thereof, based on at least one of the first virtual box, the first class, the heading direction of the second virtual box, the position of the second virtual box, the size of the second virtual box, the second class, or a combination thereof (e.g., for generating object tracks, scene graphs, or vehicle control cues, etc.).

For example, the processor 110 may be configured to assign a first identifier to the second virtual box for tracking the second virtual box (e.g., a unique ID based on timestamp, class, or location hash, etc.). For example, the processor 110 may be configured to assign a second identifier corresponding to the first identifier to the bounding box (e.g., to maintain identity consistency between detection and tracking outputs, etc.).

For example, the processor 110 may be configured to track the bounding box using the second identifier. For example, the processor 110 may be configured to track the target object based on identifying a plurality of bounding boxes that include a bounding box to which the second identifier is assigned, in a plurality of frames (e.g., through temporal association or object re-identification, etc.). For example, the second identifier may be identifier assigned to a bounding box corresponding to the target object, so the processor 110 may be configured to track the target object by identifying the bounding boxes to which the second identifier is assigned in the frames (e.g., over multiple sensor cycles or time steps, etc.).

In an example, the processor 110 may be configured to output a bounding box corresponding to the target object based on at least one of the first virtual box, the first class, the first partial points, the second class, or any combination thereof (e.g., as a hexahedral 3D box, 2D projected box, or directional polygon, etc.). For example, the bounding box may include an example of the target object represented in the virtual coordinate system in the form of a hexahedron (e.g., defined by eight corner points in 3D space, etc.).

Hereinafter, operations performed by a CPU, a GPU, and/or a NPU included in the processor 110 will be briefly described.

In an example, the processor 110 may be configured to include at least one of a CPU, a GPU, an NPU, or any combination thereof. For example, at least one of the GPU, the NPU, or any combination thereof may obtain the first virtual box and the first class based on the first neural network model (e.g., a region proposal network, transformer-based model, or YOLO-like detector, etc.). For example, at least one of the GPU or the NPU may acquire the first virtual box and the first class. For example, at least one of the GPU, the NPU, or any combination thereof may obtain scores for each of the partial classes and the points for obtaining the second class based on the second neural network model. For example, at least one of the GPU or the NPU may obtain scores for each of the partial classes and the points for obtaining the second class based on the second neural network model (e.g., probability distributions over semantic labels, etc.). For example, the CPU may classify second partial points corresponding to a designated type among the points based on performing the first designated algorithm for classifying types of each of the points for the points (e.g., such as distinguishing ground, non-ground, or noise points, etc.).

As described above, the vehicle control apparatus 100 according to an example may be configured to include at least one processor 110. The vehicle control apparatus 100 may be configured to accurately detect a target object by detecting the target object using at least one processor 110. Additionally, by performing parallel processes, the vehicle control apparatus 100 may be configured to reduce a load on each processor (e.g., enabling real-time LiDAR segmentation and object tracking, etc.).

One important thing to add in FIG. 1 is that an autonomous driving sensor 120 applied to the vehicle control apparatus 100 according to an example of the present disclosure is not limited to a LiDAR, and may instead be a radar 120. As mentioned above, at a time point at which object recognition technology that fuses various autonomous driving sensors is being introduced, there may be no need to limit the autonomous driving sensor 120 to only one type of LiDAR. Accordingly, in a case of the autonomous driving sensor 120, the reference numeral will be interchangeably used for the LiDAR 120 or the radar 120 as needed. In fact, a LiDAR and a radar are just two examples of many sensors that are usable for autonomous driving (e.g., ultrasonic sensors, stereo cameras, fisheye cameras, or infrared sensors, etc.).

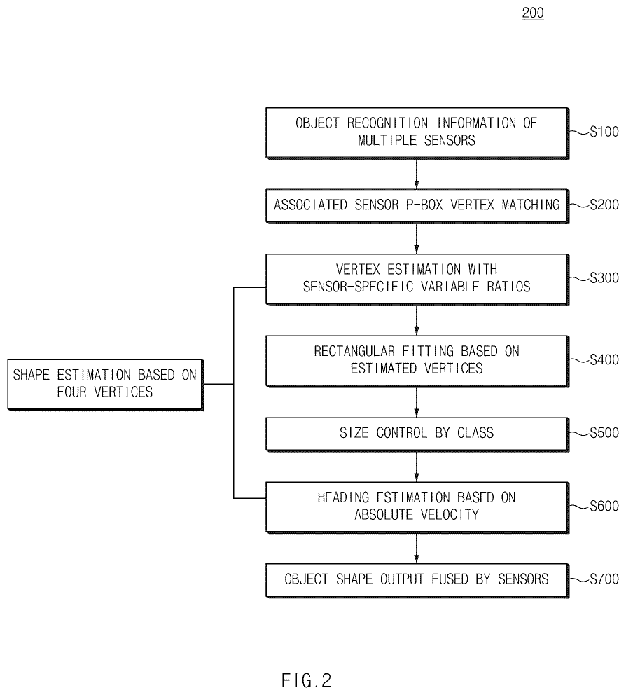

Before describing FIG. 2, the following description is added to provide a comprehensive understanding of AI object recognition according to the present disclosure, specifically regarding object recognition based on autonomous driving sensors.

An object recognition process by the autonomous driving sensor 120 and an AI module goes through three operations: preprocessing, segmentation, and tracking. For example, AI module may include and execute one or more AI models (e.g., neural networks) for preprocessing, segmentation, and tracking (e.g., detecting road surfaces, identifying vehicle outlines, or following pedestrian movement, etc.).

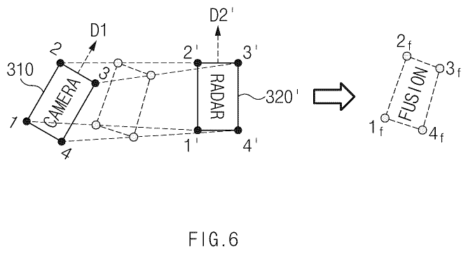

An object recognition system 1000 (see FIG. 6) according to the present disclosure goes through a preprocessing process before executing the object recognition function. The preprocessing may include, for example, removing points forming the ground based on laser/radio (or other) sensing data (i.e., unprocessed raw data) input from the autonomous driving sensor 120. Lasers/radio waves reflected from the ground may be mistakenly recognized as if there is an object on the ground, a process of distinguishing between the ground and non-ground may be performed in a preprocessing operation, and if necessary, may also be performed in a segmentation operation.

In short, the preprocessing in AI object recognition may be understood as a process in which an image processing tool of the AI module in a processor 110 removes noise from a point cloud image and reduces the total number of points existing in the point cloud image through, for example, a voxel downsampling technique to improve computational efficiency.

For reference, a point cloud image may also be displayed in a bird's eye view (BEV) mode. In a case where an autonomous driving sensor map is created to resemble a bird's eye view of a city while flying in the sky, such maps are called a BEV image (e.g., top-down views showing roads, vehicles, curbs, or crosswalks, etc.).

For example, as described above, the autonomous driving sensor 120 may emit a laser, a radio wave, or a similar signal into a surrounding environment and record the time it takes for these signals to reflect off an external object and return, thereby generating a point for each of numerous signals and determining a distance to that point. By repeating these numerous laser/radio wave emissions, the processor 110 may be configured to generate a real-time map of the surrounding environment as a three-dimensional map of the BEV type, and as a two-dimensional map if necessary (e.g., for simplified planning, navigation, or pedestrian zone detection, etc.).

Lines or surfaces appearing in black and white on a point cloud map may actually be formed of countless points, each of which is generated by the LiDAR or the radar 120, which is why autonomous driving sensing images are also referred to as point cloud images. Of course, for example, by combining an RGB-D (Red, Green, Blue—Depth) sensor with a LiDAR sensor, a LiDAR point cloud image may be reconstructed in color (e.g., to distinguish road markings, traffic signs, or construction cones, etc.).

It is challenging for a human to recognize objects using individual points within a point cloud image; however, by synthesizing the point cloud from perspectives such as a BEV or 2D plan view, it may become possible to roughly estimate the appearance of the surrounding environment of the vehicle currently in an autonomous driving mode. Furthermore, it may be possible to recognize various types of objects (e.g., a vehicle, a bus, a pedestrian, a street tree, a traffic sign, or a construction cone, etc.) within the point cloud image, and in AI image recognition technology, these human and things are referred to as objects, and each object may be classified into a specific group, known as a class, such as a vehicle class, a bus class, and so on (e.g., pedestrian class, traffic light class, or barrier class, etc.).

Distinguishing which object in the point cloud image belongs to the vehicle class or the bus class may require assistance of a deep AI neural network. To detect and identify objects within the point cloud image using the AI neural network, AI training may have to first be conducted to identify a class of each object.

For example, the dataset called PANDASET™ may include over 48,000 camera images (mostly taken in the Silicon Valley area of the United States) and more than 16,000 LiDAR scan images, which are annotated with a total of 28 classes, including pedestrians, passenger vehicles, bicycles, construction site signs, and traffic signs (e.g., stop signs, yield signs, or pedestrian crossing signs, etc.).

Furthermore, an LiDAR point cloud image may be visualized according to a user-selected option using a point cloud processing tool such as Open3D™. The LiDAR 120 may be capable of distance detection, so a 3D LiDAR image may be rendered more realistically during visual processing with a tool like Open3D™, and for instance, an object at a greater distance may be displayed in dark blue, while a closer object may be shown in light blue (e.g., rendering distant trees in blue and nearby vehicles in bright blue, etc.).

Furthermore, as mentioned above, an original image (i.e., raw data) may be preprocessed by applying a technique called voxel (3D pixel) downsampling to the point cloud image. Herein, a voxel (volumetric pixel) refers to a cube-shaped 3D pixel, and the voxel down-sampling may be a technique used to reduce a number of points in the point cloud while maintaining structures of various objects included therein, but reducing or minimizing excessive AI computation requirements.

The autonomous driving sensor 120 may emit m lasers/radio waves n times during a single scan cycle, and scan values of the lasers/radio waves that collide with and return from external objects form an (m×n) matrix, which is referred to as a range image. Each point in the point cloud image may include depth (i.e., range) information, as well as additional details such as intensity, azimuth, inclination, and other additional information of returned laser pulse (e.g., reflectivity, return number, or time-of-flight, etc.). Range images may be used for AI training with large datasets, such as Waymo™ Open Dataset (WOD).

Range view (RV) refers to a technique that converts 3D point clouds into 2D or 2.5D scenes, allowing 3D maps based on autonomous driving sensors to be represented in a way that is more intuitively understandable to humans, resembling an analog drawing rather than a collection of countless points (e.g., as a panoramic image showing lane boundaries and obstacles in a simplified layout, etc.). In a range view image, a 3D point cloud image may have 2D coordinates, but a 3D laser-related information (angle, inclination, intensity, etc.) recorded in response to obtaining the range image may not be discarded. A 3D image's (x, y, z) coordinates may be transformed into a 2D range view image by applying a width variable to the (x, y) coordinates to obtain the coordinates of one axis in two dimensions and applying a height variable and range image information indicating a range (depth) to the (z) coordinate to obtain the coordinates of another axis in two dimensions (e.g., mapping lateral position to image width and vertical angle or elevation to image height, etc.).

Furthermore, the AI algorithm according to the present disclosure may include a convolutional neural network (CNN), which is an AI training module frequently used to determine features (or feature points) from image data (e.g., edges, corners, textures, or object outlines, etc.). For this purpose, there are commercially available datasets including tens of thousands of images, and CNNs currently exist in versions that can process images from one-dimensional to three-dimensional (e.g., 1D for signal patterns, 2D for camera images, or 3D for LiDAR voxel grids, etc.). For example, results from a range view image processing tool are trained by a CNN neural network to perform a function of helping AI accurately recognize objects in an image.

Objects around autonomous vehicles may be ultimately recognized by machines, so generation of a ground truth (GT) bounding box on the aforementioned autonomous driving sensor map may also be a critical step in object recognition. In machine learning, GT (ground truth) is a term used to indicate an original or actual value of data that AI is trying to learn (e.g., the real position of a pedestrian, car, or traffic cone, etc.). Typically, a bounding box with a box-shaped boundary may be considered a type of image annotation applied to a point cloud image.

For example, the AI module may retrieve labels to recognize objects and group various objects (e.g., grouping multiple detected vehicles into a vehicle class or pedestrians into a pedestrian class, etc.). Of course, an interval of 3D data points used to output a GT bounding box may also be set, and one GT bounding box may be set to include 50 to 1000 cloud points (e.g., depending on the object's size or scan density, etc.).

Of course, the GT annotation may not exist in raw data captured by sensors such as the radar (or LiDAR) 120 while the vehicle is driving. The processor 110 may have to recognize objects belonging to various classes, such as a road sign, a crosswalk, a pedestrian, another vehicle, a center lane, or a guardrail, etc., as objects, and GT annotation may serve as a means to measure object recognition errors by comparing object determination results recognized by the AI algorithm of the processor 110 with actual outcomes, and they are sometimes used to evaluate AI performance. The GT bounding box, which is applied to an original image in the form of annotation, may be set manually by a user, but there is also a commercially available GT calculation tool, such as grid-striding (e.g., dividing a space into grid cells and labeling each cell's contents, etc.).

In a case where the AI object recognition module is driven, predicted bounding boxes may also be observed. A result recognized by the processor 110 as an object of a specific class from original image data obtained from the sensor 120, etc., may appear in a form of another bounding box similar to the GT bounding box. Unlike the GT bounding box, the predicted bounding boxes may be computational results of autonomous driving AI. The predicted bounding box may match the GT bounding box, but the predicted bounding box may not match the GT bounding box or may not overlap the GT bounding box at all (e.g., due to sensor noise, occlusion, or misclassification, etc.).

For reference, the predicted bounding boxes alone may not definitively determine that an object of a specific class actually exists at a certain position, so the predicted bounding boxes may be usually called P-Boxes (probability boxes) or predicted bounding boxes.

Segmentation processing performed after preprocessing refers to, for example, displaying a specific part of a road (e.g., a traffic light) in red and the rest (asphalt road) in blue (e.g., for class-based color labeling, etc.). Clustering point clouds into certain groups and generating P-Boxes may also be done at the segmentation operation. For reference, there exists a technique called cluster expansion, where an expansion target may include all points within an epsilon distance (a minimum distance constituting a cluster) from a seed point (e.g., expanding a group of adjacent car-surface points into a full vehicle object, etc.).

During segmentation processing, clustering and P-Box generation may be performed based on a point cloud. In short, an AI network performing segmentation is used to obtain a point label from the autonomous driving sensor 120 (e.g., labeling a point as road, curb, or obstacle, etc.).

In the present disclosure, a “rule-based” road surface recognition and label fusion technique may be proposed to solve a problem of ground recognition errors occurring during segmentation. Such road surface recognition algorithms may apply any of a variety of techniques, including slope-based road surface recognition, grid-based road surface recognition, and other non-planar-based road surface recognition (e.g., for detecting curved ramps, uneven terrain, or multi-elevation surfaces, etc.).

For reference, semantic segmentation indicates a task of attaching a unique class label to each point in a point cloud generated by the autonomous driving sensor 120. In point-based image processing technology, semantic segmentation is a technique used to determine meaningful information from autonomous driving sensor data, aimed at enabling object recognition or scene reconstruction necessary for implementing autonomous driving (e.g., identifying roads, sidewalks, vehicles, or vegetation, etc.). Various semantic segmentation AI models, (e.g., a projection-based method, a point-based method, and a sparse convolution-based method) may be applied. For example, a result of semantic segmentation may be an outcome of AI computations performed by the processor 110 using a NVIDIA DRIVE™ AGX system, and through such a configuration, various colors may be added to a point cloud image (e.g., coloring vehicles in red, pedestrians in yellow, or road surfaces in gray, etc.).

After the segmentation process as above, the sensor image may go through a process called postprocessing. The postprocessing refers to converting point cloud data into 3D maps or modeling, to extract meaningful information for autonomous driving. Postprocessing may also include a process of finally removing noise and errors from the point cloud image, recognizing objects such as vehicles and pedestrians from the point cloud, and, if necessary, registering point cloud information by attaching a unique identifier thereto e.g., for object tracking, localization, or scene mapping, etc.). Assigning a confidence score to each object or P-Box recognized by AI may also be performed in the postprocessing operation (e.g., to filter out uncertain detections or rank object priority, etc.).

Hereinafter, a core algorithm of the present disclosure will be described with reference to FIG. 2.

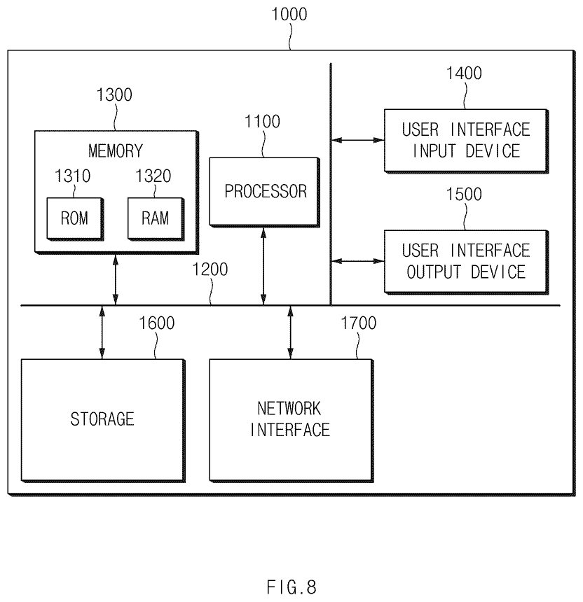

FIG. 2 shows an example overall algorithm 200 for recognizing an object by an AI module by fusing measurement results of two or more autonomous driving sensors. The algorithm 200 in FIG. 2 may be implemented and executed as an AI module installed in the processor 100 in FIG. 1, and the system 1000, which recognizes objects and evaluates their reliability through the AI module and autonomous driving sensors according to the present disclosure, may correspond to the computing system 1000 in FIG. 8, including the algorithm 200 in FIG. 2.

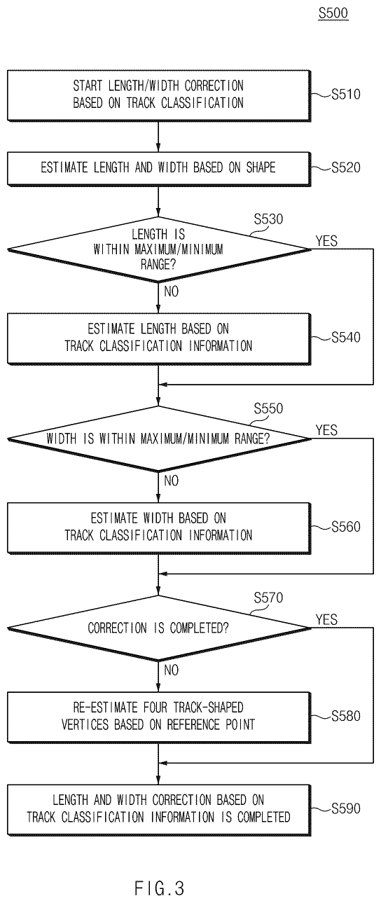

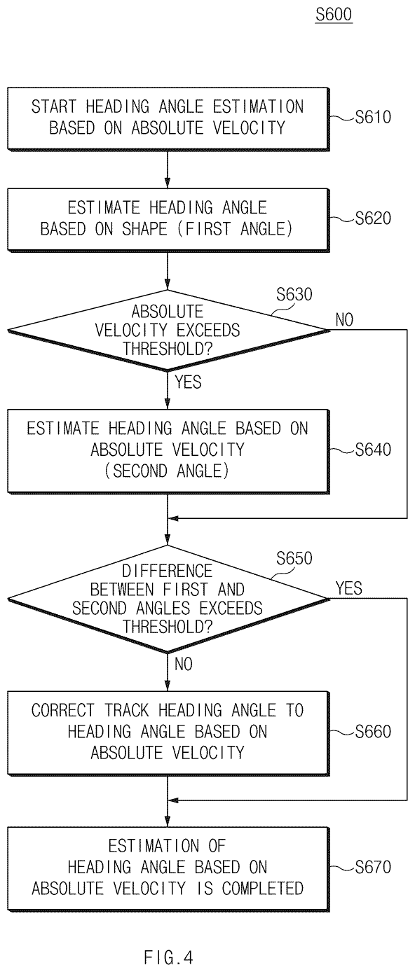

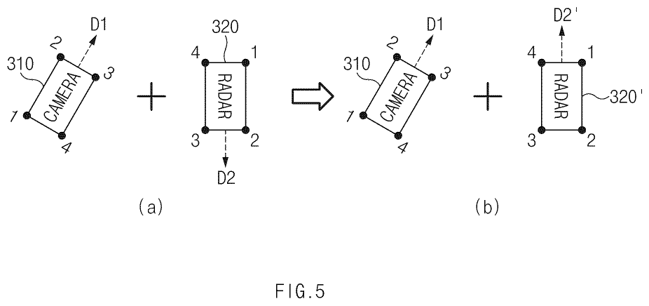

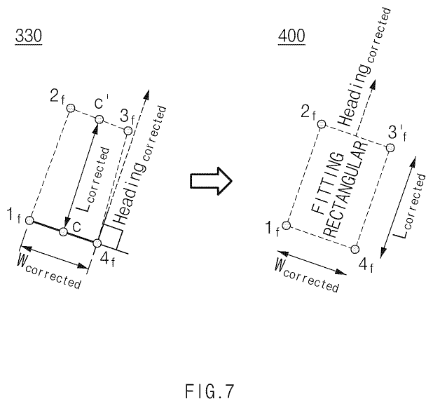

In describing FIG. 2, reference will be made to FIG. 3 to FIG. 7 as necessary. FIG. 3 shows an example process for correcting a length and a width based on a track class (e.g., adjusting dimensions for pedestrian, bicycle, or vehicle classes, etc.). FIG. 4 shows an example process for finally determining a heading vector of an object corresponding to a track class based on absolute velocity (e.g., using speed and direction to refine the object's orientation, etc.). FIG. 5 shows an example of a method of fusing shape information and heading information of an object recognized by two or more autonomous driving sensors (e.g., combining outputs from LiDAR and radar to generate a consistent bounding box, etc.). FIG. 6 shows an example process of generating a fused P-Box according to a predetermined weight assigned to two or more autonomous driving sensors (e.g., weighting shape data from a camera more heavily than from a radar, etc.). FIG. 7 shows an example fitting rectangle derived from information obtained from two or more autonomous driving sensors, and displaying a corrected length, a corrected width, and corrected heading corresponding thereto (e.g., a clean rectangular box around a vehicle with refined orientation and size, etc.).

First, referring to FIG. 2, in Operation S100, the AI module according to the present disclosure may receive information recognizing objects belonging to various classes existing in a surrounding environment during autonomous driving from a plurality of autonomous driving sensors 120 (e.g., identifying a car, a cyclist, or a tree, etc.).

Herein, the autonomous driving sensor 120 may be the LiDAR illustrated in FIG. 1, but may also include various other sensors such as high-performance cameras and radars (e.g., monocular cameras, stereo cameras, or millimeter-wave radar, etc.). The present disclosure relates to fusion of sensor measurement results, so the present disclosure assumes that at least two types of autonomous driving sensors 120 are mounted on a running vehicle.

In Operation S200, for example, assuming that among two or more autonomous driving sensors 120, a camera sensor and a radar sensor may be mutually associated sensors, an action is performed to match four vertices of a P-Box determined from a camera and a P-Box determined from a radar (e.g., aligning corresponding corners of object bounding boxes detected independently by each sensor, etc.).

For example, in the present disclosure, among two or more autonomous driving sensors, at least one may be set as a reference sensor (in this example, a camera is used as the reference sensor), and at least one other sensor (for instance, a radar in this example) may be set as a second sensor, and shape information, including at least four vertex position data and heading angle information for object recognition, may be received from the reference sensor and the second sensor to generate a reference P-Box and a second P-Box respectively, after which the vertices may be matched (e.g., by aligning corner indices or bounding box orientations, etc.).

In a case of three dimensions, the P-Box takes the form of a hexahedron with eight vertices, and spatial coordinates of each vertex are also three-dimensional; however, for the sake of convenience in description, the reference P-Box recognized by the camera and the second P-Box recognized by the radar are assumed to be rectangular shapes with four vertices (e.g., projected onto a 2D plane such as the ground surface, etc.).

For example, in Operation S200, among the aforementioned second P-Boxes (i.e., the numerous P-Boxes related to objects recognized by the radar), the one closest to the shape information and heading angle information of the reference P-Box (i.e., the shape recognized by the camera sensor, which is considered to have high shape reliability and is thus used as the reference sensor) may be selected as the vertex alignment target P-Box. Next, the four vertex position data of the alignment target P-Box may be corrected based on the four vertex position data of the reference P-Box, thereby generating a fusion P-Box by fusing the alignment target P-Box and the reference P-Box (e.g., averaging or weighting corresponding corners from both P-Boxes to produce a unified bounding box, etc.).

Operation S200 may be more clearly understood through FIG. 5. FIG. 5A illustrates a reference P-Box 310 measured by a camera sensor and a second P-Box 320 measured by a radar. The second P-Box 320 depicted in FIG. 5A is the alignment target P-Box 320, selected due to its high similarity to the reference P-Box 310 in terms of shape information and heading information, particularly shape information in the case of FIG. 5A (e.g., contour geometry or aspect ratio, etc.). (For reference, D1 indicates a heading vector of the reference P-Box 310, D2 indicates a heading vector originally measured by the radar, and D2′ indicates a new (i.e. more accurate) heading after vertex alignment.).

As shown in FIG. 5A, an order of the vertices measured by the camera may correspond to 1, 2, 3, and 4 in the reference P-Box 310, whereas an order of the vertices measured by the radar may follow 3, 4, 1, and 2 with respect to the second P-Box, which is an alignment target. Herein, according to the present disclosure, considering that the camera can serve as a reference due to its superiority over the radar sensor in determining ‘shape,’ if the four vertex orders of the alignment target, the second P-Box 320, are rearranged to match the vertex order of the reference P-Box 310, the ‘alignment target P-Box with corrected vertices’ (i.e., reference numeral 320′) illustrated in FIG. 5B is fused with the reference P-Box 310 (e.g., aligning front-left, front-right, rear-right, and rear-left corners in the same clockwise order, etc.).

In Operation S300, for example, using a first shape ratio ω₁, assigned as a weight for the camera sensor, and a second shape ratio ω₂, assigned as a weight for the radar sensor, four vertices may be estimated to fuse the reference P-Box and second P-Box which are described above. For example, in the present disclosure, in a case where results recognized by two or more autonomous driving sensors 120 are fused, the P-Box generated through this fusion may be defined as a fusion P-Box, and in the instant case, Operation S300 may adopt a method of applying weight ratios ( ω₁, ω₂) to vertex coordinate values measured by each of the two sensors to determine four vertices that compose the fusion P-Box (e.g., with ω₁=0.7 and ω₂=0.3 when prioritizing camera input, etc.).

For reference, in Operation S300, a process for obtaining the coordinate values of the four vertices of the fusion P-Box may be executed by determining virtual vertices one by one, based on the first shape ratio applied to the reference P-Box (i.e., ω₁ as previously mentioned) and the second shape ratio applied to the alignment target P-Box (i.e., ω₂ as previously mentioned) on four virtual connecting lines that connect four vertices of the alignment target P-Box with four vertices position information corrected and four vertices of the reference P-Box in an alignment order. Herein, a sum of the first shape ratio ω₁ and the second shape ratio ω₂ is set to equal 1 (e.g., ω₁+ω₂=1.0 to maintain geometric balance during fusion, etc.).

Referring to FIG. 6, Operation S300 may be understood more clearly. Referring to FIG. 6, the process described in FIG. 5 aims to fuse the alignment target P-Box 320 (with corrected vertices) with the reference P-Box 310. In the instant case, according to the present disclosure, four virtual lines may be created by connecting the vertices 1-1′, 2-2′, 3-3′, and 4-4′, and four points corresponding to a ω₁: ω₂ ratio on these lines may be identified and determined as 1_{f}, 2_{f}, 3_{f}, and 4_{f}, as illustrated on the right side of FIG. 6. A fusion P-Box 330 may be formed with the four vertices 1_{f}, 2_{f}, 3_{f}, and 4_{f}(e.g., representing a weighted geometric blend of the two sensor outputs, etc.)

Once the fusion P-Box is derived according to Operation S300, the process proceeds to Operation S400, where the fusion P-Box is adjusted into a ‘fitting rectangle’ form. In other words, the fusion P-Box formed in Operation S300 is a quadrilateral but is likely not a rectangle.

Accordingly, in Operation S400, the fusion P-Box with a ‘quadrilateral’ shape may undergo a process of adjustment into a ‘fitting rectangle’ shape, formed of at least four vertices and four sides, to achieve a ‘rectangular’ form (e.g., simplifying geometry for further processing or visualization, etc.).

Specifically, in Operation S400, a process may be performed to set a side closest to two or more autonomous driving sensors (i.e., camera and radar) and unaffected by occlusion among the at least four sides forming the fusion P-Box (assuming a two-dimensional spatial coordinate system), as the reference side, followed by the execution of a process where i) determining a width of this reference side as the ‘corrected width’ of the ‘fitting rectangle,’ ii) determining the corrected length of the fitting rectangle by connecting a first center point of the reference side with a second center point of a second side positioned opposite the reference side, and iii) determining a vector perpendicular to the reference side and directed from the reference side toward the second side as the corrected heading of the fitting rectangle (e.g., indicating the forward direction of the detected object, etc.).

Referring to FIG. 7, Operation S400 may be understood with greater clarity. In other words, in the fusion P-Box 330 completed according to the process described in FIG. 6, a side connecting the vertices 1_{f} and 4_{f} may be assumed to be the closest side to the vehicle equipped with the autonomous driving sensors 120, such as a radar and a camera. In the instant case, the side connecting 1_{f} and 4_{f} may be considered to have the least noise, and may accordingly be designated as the ‘reference side’ (e.g., because it is not affected by occlusion from other nearby objects or sensor blind spots, etc.).

Now, a distance of the straight line connecting a midpoint c of the reference side and a midpoint c′ of the second side positioned opposite to the reference side (i.e., the side connecting 2_{f} and 3_{f}) may become a ‘corrected length L_{corrected}.’

A width of the reference side may directly be utilized as the ‘corrected width W_{corrected}.’

The corrected heading may indicate a vector perpendicular to the reference side, directed towards the second side, which is depicted as Heading_{corrected} in FIG. 7. Now, in the example of FIG. 7, a fitting rectangle 400 may be fully equipped with the initially corrected shape and heading information, namely the corrected width W_{corrected}, corrected length L_{corrected}, and corrected heading Heading_{corrected}.

In Operation S500, the corrected length and corrected width of the fitting rectangle may be subjected to secondary correction based on track class information corresponding to the fusion P-Box (e.g., pedestrian class, truck class, passenger car class, motorcycle class, bicycle class, etc.). For example, based on the track class information, in a case where an object currently being processed belongs to the pedestrian class, the length and width of the fitting rectangle produced over 3 m may be determined as minimum and maximum values (e.g., minimum length 0.5 m, maximum 3 m; minimum width 0.5 m, maximum 2 m, etc.), and then the length and width may be secondarily corrected as they fall within a range of the minimum and maximum values set as above.

In Operation S600, among at least four vertices of the fusion P-Box, the vertex with highest reliability may be set as the reference vertex (e.g., a vertex measured with minimal occlusion or noise, etc.), and track class information of the recognized specific object may be inversely corrected based on the reference vertex, the secondarily corrected length, and the secondarily corrected width. Next, based on a track absolute velocity, which is an absolute velocity of the reversely corrected track class information, the heading that was not previously corrected may be secondarily corrected (e.g., refining heading direction for a fast-moving vehicle versus a stationary object, etc.).

Specifically, four heading candidates may be determined from the four sides that constitute the inversely corrected track class information, and one closest to the absolute velocity among the determined heading candidates may be determined as a secondarily corrected heading vector of the inversely corrected track class information (e.g., selecting the most plausible heading direction for a moving truck or cyclist, etc.).

Thereafter, in Operation S700, object shape information for which sensor fusion has been completed after going through all processes up to Operation S600 may be output (e.g., as final input to path planning or collision avoidance modules, etc.).

FIG. 3 illustrates a detailed flowchart showing Operation S500, as described in FIG. 2. In other words, at the beginning of the secondary correction process for length and width in Operation S510, it may be important to note that, in the present disclosure, ‘track’ includes classification (i.e., class) information such as vehicles, pedestrians, animals, and stationary objects (e.g., cones, stop signs, or fallen branches, etc.).

In Operation S520, length and width information may be determined based on four vertex estimation results up to Operation S400, and then the length and width may be estimated based on shape information for specific class classification information of the track. For example, based on the track information, in a case where a length of a specific type of the truck object is 3 m and a width thereof is 1.5m, an approximate length and width of the object currently under analysis may be estimated (e.g., 2.8 m and 1.4 m for a compact delivery truck, or 3.2 m and 1.6 m for a light-duty flatbed, etc.).

In Operation S530, for example, based on the assumed minimum length, maximum length, minimum width, and maximum width values for the specific truck mentioned above, it may be determined whether the length of the fitting rectangle obtained in Operation S400 exceeds these maximum and minimum values (e.g., length over 5 m or under 1.5 m may be flagged for correction, etc.).

In a case where the length of the fitting rectangle is determined to fall within the maximum/minimum range in Operation S530, a YES determination may be made in Operation S530, leading to Operation S550, while in a case where a NO determination is made, the length may be estimated based on the track classification information in Operation S540 for secondary correction

In other words, the length of the fitting rectangle may be corrected to fall within the minimum and maximum length range that is appropriate for the corresponding object (e.g., between 0.5 m and 3 m for pedestrians, etc.).

In Operation S550, the width may be adjusted. In a case where the width is determined to fall within the maximum/minimum range (e.g., between 0.5 m and 2.5 m for a vehicle class, etc.), the YES determination may be made, and the process proceeds to Operation S570, while in a case where the NO determination is made, the process moves to Operation S560, where the width is estimated based on the track classification information and corrected to ensure that the width of the fitting rectangle falls within the minimum/maximum width range.

In Operation S570, after verifying whether the corrections for the width and length of the fitting rectangle have been completed, the YES determination may lead to Operation S590, where the length and width correction process based on the track classification (class) information according to the present disclosure may be completed. In a case where the NO determination is made in Operation S570, the process moves to Operation S580, where the four vertices of the track shape are re-estimated based on the reference point (e.g., the most stable vertex based on track location, signal quality, or sensor agreement, etc.). To clarify, the reference point herein refers to the reference point of the object position recognized by the fusion P-Box, which is understood as the fused object position set independently from shape estimation (e.g., centroid based on merged sensor outputs, etc.).

Furthermore, the reference point may be determined as the vertex with highest reliability and accuracy based on the position of the track. For example, in a case where the track is positioned at the front left of the vehicle, the vertex at the rear right of the track may be selected as a point with the highest accuracy and reliability, and in a case where the track is positioned at the front right, the vertex at the rear left of the track may be selected as the point with the highest accuracy and reliability (e.g., due to minimal sensor occlusion in those zones, etc.).

FIG. 4 illustrates a detailed flowchart that breaks down Operation S600 of FIG. 2. In Operation S610, the heading vector considering a direction of movement, may be estimated based on the ‘track absolute velocity.’

Herein, the ‘track absolute velocity’ may be independent of the track's own velocity, i.e., the movement velocity of the vehicle itself, and may be determined as a sum of the ‘track relative velocity’ and the ‘vehicle absolute velocity.’

In Operation S620, a heading angle may be estimated based on the shape, and this is conveniently referred to as a first heading angle. For the shape-based track, the four sides may become candidates for the base, and accordingly, four heading angles may be derived as candidates based on each candidate base.

In a case where the absolute velocity of the track is determined to be, e.g., 0 in Operation S630, the process may proceed to Operation S670 to complete the heading angle estimation process based on the absolute velocity.”

On the other hand, if the absolute velocity is determined to exceed a certain threshold in Operation S630, the process may proceed to Operation S640 to estimate the heading angle (second angle) based on the absolute velocity. In the instant case, among the four heading vector candidates, a heading vector most similar to the absolute velocity vector of the track may be selected as the track's heading (second angle).

In Operation S650, it may be determined whether a difference between the first and second angles exceeds a certain threshold. If not, the process may proceed to Operation S670 to terminate this process. In the case of the YES determination in Operation S660, the process may move to Operation S660 to correct the track heading angle based on the absolute velocity.

Of course, in the present disclosure, during correction of length and width based on track classification information, a reference point may be changed to a central point or another suitable location instead of one of the four vertices. A method for setting the reference point may be applied during the correction of length and width, rather than during the correction based on the classification information. Furthermore, in the present disclosure, selection of the reference point may be flexibly applied using various strategies based on an output characteristic of a sensor being utilized. For example, as previously exemplified, it may be acceptable for the camera not to serve as the reference sensor, and although the reference point itself is selected differently from what was described earlier, such variation may not affect the core principles of the present disclosure. Furthermore, track information estimation through estimation of four vertices may, of course, be flexibly applied even if there are two or more sensors, such as three or four.

According to the present disclosure, through the aforementioned technical features, it may become possible to accurately estimate a shape of an object based on key attribute information, such as a length, a width, and a heading vector, and to reduce shaking or rotational phenomena of the target object caused by changes in the heading angle.

Furthermore, according to the present disclosure, the accuracy of representing actual behaviors of objects surrounding the vehicle during autonomous driving is expected to improve significantly based on object shape estimation results derived from sensor fusion.

In typical autonomous driving scenarios, most target tracks correspond to the vehicle class, and such vehicles generally move in a linear direction rather than rotating. By incorporating this motion characteristic into the estimation process, the likelihood of misrecognition—such as detecting abnormal or erratic object shapes—may be reduced.

In particular, it is expected that use of object attribute information, such as a length, a width, and heading, for object shape estimation may minimize special handling across various scenarios. For example, the present disclosure may implement an algorithm that identifies such error scenarios, including cases where the same object has heading angles between sensors that are opposite or nearly 90 degrees apart, or where the length and width are incorrectly reversed as width and length, and performs special handling through correction.

For example, instead of deriving an AI prediction box based on object attributes, by adopting a method that derives object attributes inversely using the four vertices of the box instead of deriving an AI prediction box based on object attributes, it may be possible to significantly reduce AI computation load and prevent errors in computation results in a case of addressing the aforementioned error scenarios.

FIG. 8 shows an example computing system 1000 for autonomous vehicle control and object recognition computation (e.g., shape estimation, sensor fusion, or track classification, etc.).

Referring to FIG. 8, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600 (e.g., SSD, flash memory, or HDD, etc.). The memory 1300 and the storage 1600 may include various types of volatile or nonvolatile storage media. For example, the memory 1300 may include a read only memory (ROM) and a random access memory (RAM) (e.g., DRAM or SRAM).

Accordingly, steps of a method or algorithm described in connection with the examples included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM (e.g., SSD, USB drive, or optical media).

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal (e.g., an onboard vehicle controller or mobile computing platform). Alternatively, the processor and the storage medium may reside as separate components within the user terminal.

A first example of the present disclosure relates to a system that recognizes an object by an AI module by fusing measurement results from of the first side two or more autonomous driving sensors, including a processor configured to include an object recognition module as part of the AI module that recognizes an object existing in a surrounding environment based on data input from the two or more autonomous driving sensors, and a memory configured to store point cloud data, wherein the AI module performs a first operation of setting at least a first one of the two or more autonomous driving sensors as a reference sensor and at least a second one as a second sensor, and receiving shape information, including at least four vertex position details for object recognition, as well as heading angle information from the reference sensor and the second sensor, to generate a reference P-Box and a second P-Box, respectively, a second operation of selecting a P-Box that is closest to the shape information and the heading angle information of the reference P-Box from among second P-Boxes, as alignment target P-Box, and a third operation of correcting the four vertex position information of the alignment target P-Box based on the four vertex position information of the reference P-Box, and then generating a fusion P-Box by fusing the alignment target P-Box and the reference P-Box.

In a case of an autonomous driving sensor fusion system by AI according to a second example of the present disclosure, the third operation may include obtaining coordinate values of four vertices of the fusion P-Box by determining virtual vertices one by one, based on a first shape ratio applied to the reference P-Box and a second shape ratio applied to the alignment target P-Box on four virtual connecting lines that connect four vertices of the alignment target P-Box with four vertices position information corrected and four vertices of the reference P-Box in an alignment order.

In a case of an autonomous driving sensor fusion system by AI according to a third example of the present disclosure, a sum of the first shape ratio ω₁ and the second shape ratio ω₂ may be equal to 1.

In a case of an autonomous driving sensor fusion system by AI according to a fourth example of the present disclosure, it may additionally perform a fourth operation of correcting a quadrangular shape of the fusion P-Box to a fitting rectangular shape including at least four vertices and four sides.

In a case of an autonomous driving sensor fusion system by AI according to a fifth example of the present disclosure, the fourth operation may include setting a side closest to the two or more autonomous driving sensors and unaffected by occlusion among the at least four sides forming the fusion P-Box, as a reference side, determining a width of the reference side as a corrected width of the fitting rectangle, determining the corrected length of the fitting rectangle by connecting a first center point of the reference side with by connecting a first center point of the reference side with a second center point of a second side positioned opposite the reference side, and determining a vector perpendicular to the reference side and directed from the reference side toward the second side as the corrected heading of the fitting rectangle.

In a case of an autonomous driving sensor fusion system by AI according to a sixth example of the present disclosure, it may additionally perform a fifth operation of secondarily correcting a corrected length and corrected width of the fitting rectangle based on track class information corresponding to the fusion P-Box.

In a case of an autonomous driving sensor fusion system by AI according to a seventh example of the present disclosure, the fifth operation include determining minimum and maximum values of length and width from the track class information, and then determining the corrected length and corrected width within a range between the minimum and maximum values.

In a case of an autonomous driving sensor fusion system by AI according to an eighth example of the present disclosure, it may additionally perform a sixth operation of setting a vertex with highest reliability among the at least four vertices of the fusion P-Box, as a reference vertex, and inversely correcting the track class information based on the reference vertex, the secondarily corrected length, and the secondarily corrected width.

In a case of an autonomous driving sensor fusion system by AI according to a ninth example of the present disclosure, it may additionally perform a seventh operation of secondarily correcting the corrected heading based on a track absolute velocity, which is an absolute velocity of the reversely corrected track class information.

In a case of an autonomous driving sensor fusion system by AI according to a tenth example of the present disclosure, the seventh operation may include determining four heading candidates from four sides that constitute the inversely corrected track class information, and determining one closest to the absolute velocity among the determined heading candidates as a secondarily corrected heading vector of the inversely corrected track class information.

An eleventh example of the present disclosure relates to a method that recognizes an object by an AI module by fusing measurement results from of the first side two or more autonomous driving sensors, including operations, performed by the AI module, including a first operation of setting at least a first one of the two or more autonomous driving sensors as a reference sensor and at least a second one as a second sensor, and receiving shape information, including at least four vertex position details for object recognition, as well as heading angle information from the reference sensor and the second sensor, to generate a reference P-Box and a second P-Box, respectively, a second operation of selecting a P-Box that is closest to the shape information and the heading angle information of the reference P-Box from among second P-Boxes, as alignment target P-Box, and a third operation of correcting the four vertex position information of the alignment target P-Box based on the four vertex position information of the reference P-Box, and then generating a fusion P-Box by fusing the alignment target P-Box and the reference P-Box.

According to the present disclosure, through the aforementioned technical features suggested in the first to eleventh examples described above, it may become possible to accurately estimate a shape of an object based on key attribute information, such as a length, a width, and a heading vector, and to reduce shaking or rotational phenomena of the target object caused by changes in the heading angle.

Furthermore, according to the present disclosure, it is expected that performance reflecting actual behaviors of objects surrounding the vehicle during autonomous driving will be significantly improved based on object shape estimation results derived from sensor fusion.

During autonomous driving, a most common target track on a road may belong to the vehicle class, and vehicles may realistically move in linear motion more often than in rotational situations, so incorporating this characteristic may reduce misrecognition phenomena where the object shape exhibits abnormal behavior.

In particular, it is expected that use of object attribute information, such as a length, a width, and heading, for object shape estimation may minimize special handling across various scenarios. For example, the present disclosure may implement an algorithm that identifies such error scenarios, including cases where the same object has heading angles between sensors that are opposite or nearly 90 degrees apart, or where the length and width are reversed as width and length, and performs special handling through correction.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed is:

1. An apparatus of a vehicle, the apparatus comprising:
a processor; and
a memory storing at least one instruction that, when executed by the processor communicating with the memory, is configured to cause the apparatus to:
set at least one reference sensor among a plurality of sensors of the vehicle and set at least one second sensor among the plurality of sensors, and
obtain, from the at least one reference sensor and the at least one second sensor, shape information and heading angle information, wherein the shape information comprises at least four vertices position information of an object existing in a surrounding environment of the vehicle, and wherein the object is recognized based on an artificial intelligent model by fusing data input from at least two sensors of the plurality of sensors,
generate, based on the shape information and the heading angle information from the at least one reference sensor, a reference predicted bounding box (P-Box),
generate, based on the shape information and the heading angle information from the at least one second sensor, at least one second P-Box,
select an alignment target P-Box among the at least one second P-BOX, wherein the alignment target P-Box is selected based on a highest similarity to the shape information of the reference P-Box and the heading angle information of the reference P-Box,
based on four vertices position information of the reference P-Box, adjust four vertices position information of the alignment target P-Box,
based on the adjusted four vertices position information of the alignment target P-Box, generate a fusion P-Box by fusing the alignment target P-Box and the reference P-Box,
output a signal indicating an object recognized based on the fusion P-Box, and
control, based on the signal, autonomous driving of the vehicle.

2. The apparatus of claim 1, wherein the at least one instruction, when executed by the processor communicating with the memory, is configured to cause the apparatus to obtain coordinate values of four vertices of the fusion P-Box by:
determining virtual vertices, based on a first shape ratio applied to the reference P-Box and a second shape ratio applied to the alignment target P-Box on four virtual connecting lines, wherein the four virtual connecting lines connect four vertices of the alignment target P-Box with the adjusted four vertices position information and four vertices of the reference P-Box in an alignment order.

3. The apparatus of claim 2, wherein a sum of the first shape ratio and the second shape ratio is equal to one.

4. The apparatus of claim 1, wherein the at least one instruction, when executed by the processor communicating with the memory, is configured to cause the apparatus to adjust a quadrangular shape of the fusion P-Box to a fitting rectangular shape, wherein the fitting rectangular shape comprises at least four vertices and four sides.

5. The apparatus of claim 4, wherein the at least one instruction, when executed by the processor communicating with the memory, is configured to cause the apparatus to adjust the quadrangular shape of the fusion P-Box by:
setting a reference side among at least four sides forming the fusion P-Box, wherein the reference side is a side closest to the plurality of sensors and unaffected by occlusion,
determining a width of the reference side as an adjusted width of the fitting rectangular shape,
determining an adjusted length of the fitting rectangular shape by connecting a first center point of the reference side with a second center point of a second side positioned opposite to the reference side, and
determining a vector perpendicular to the reference side and directed from the reference side toward the second side as an adjusted heading of the fitting rectangular shape.

6. The apparatus of claim 4, wherein the at least one instruction, when executed by the processor communicating with the memory, is configured to cause the apparatus to, based on track class information corresponding to the fusion P-Box, readjust an adjusted length of the fitting rectangular shape and an adjusted width of the fitting rectangular shape.

7. The apparatus of claim 6, wherein the at least one instruction, when executed by the processor communicating with the memory, is configured to cause the apparatus to readjust the adjusted length of the fitting rectangular shape and the adjusted width of the fitting rectangular shape by:
determining, based on the track class information, minimum and maximum values of length and width of the fitting rectangular shape, and
determining the adjusted length and the adjusted width within a range between the minimum and maximum values of length and width of the fitting rectangular shape.

8. The apparatus of claim 6, wherein the at least one instruction, when executed by the processor communicating with the memory, is configured to cause the apparatus to:
set a reference vertex, wherein the reference vertex is a vertex with a highest reliability among at least four vertices of the fusion P-Box, and
based on the reference vertex, the readjusted length of the fitting rectangular shape, and the readjusted width of the fitting rectangular shape, inversely adjust the track class information.

9. The apparatus of claim 8, wherein the at least one instruction, when executed by the processor communicating with the memory, is configured to cause the apparatus to readjust, based on a track absolute velocity, the adjusted heading of the fitting rectangular shape, wherein the track absolute velocity is an absolute velocity of an object recognized based on the fusion P-Box and adjusted based on the inversely adjusted track class information.

10. The apparatus of claim 9, wherein the at least one instruction, when executed by the processor communicating with the memory, is configured to cause the apparatus to readjust the adjusted heading of the fitting rectangular shape by:
identifying four heading candidates based on four sides associated with the inversely adjusted track class information, and
selecting, among the identified four heading candidates, a heading candidate that is most closely aligned with the absolute velocity, as a readjusted heading vector associated with the inversely adjusted track class information.

11. A method performed by an apparatus of a vehicle, the method comprising:
setting at least one reference sensor among a plurality of sensors of the vehicle and setting at least one second sensor among the plurality of sensors;
obtaining, from the at least one reference sensor and the at least one second sensor, shape information and heading angle information, wherein the shape information comprises at least four vertices position information of an object in a surrounding environment of the vehicle, wherein the object is recognized based on an artificial intelligent model by fusing data input from at least two sensors of the plurality of sensors;
generating, based on the shape information and the heading angle information from the at least one reference sensor, a reference predicted bounding box (P-Box);
generating, based on the shape information and the heading angle information from the at least one second sensor, at least one second P-Box;
selecting an alignment target P-Box among the at least one second P-Box, wherein the alignment target P-Box is selected based on a highest similarity to the shape information and the heading angle information of the reference P-Box;
based on four vertices position information of the reference P-Box, adjusting the four vertices position information of the alignment target P-Box;
based on the adjusting of the four vertex position information of the alignment target P-Box, generating a fusion P-Box by fusing the alignment target P-Box and the reference P-Box;
outputting a signal indicating an object recognized based on the fusion P-Box; and
controlling, based on the signal, autonomous driving of the vehicle.

12. The method of claim 11, wherein the adjusting of the four vertices position information comprises:
obtaining coordinate values of four vertices of the fusion P-Box by determining virtual vertices, based on a first shape ratio applied to the reference P-Box and a second shape ratio applied to the alignment target P-Box on four virtual connecting lines, wherein the four virtual connecting lines connect four vertices of the alignment target P-Box with the adjusted four vertices position information and four vertices of the reference P-Box in an alignment order.

13. The method of claim 12, wherein a sum of the first shape ratio and the second shape ratio is equal to one.

14. The method of claim 11, further comprising adjusting a quadrangular shape of the fusion P-Box to a fitting rectangular shape, wherein the fitting rectangular shape comprises at least four vertices and four sides.

15. The method of claim 14, wherein the adjusting of the quadrangular shape of the fusion P-Box comprises:
setting a reference side among at least four sides forming the fusion P-Box, wherein the reference side is a side closest to the plurality of sensors and unaffected by occlusion,
determining a width of the reference side as an adjusted width of the fitting rectangular shape,
determining an adjusted length of the fitting rectangular shape by connecting a first center point of the reference side with a second center point of a second side positioned opposite to the reference side, and
determining a vector perpendicular to the reference side and directed from the reference side toward the second side as an adjusted heading of the fitting rectangular shape.

16. The method of claim 14, further comprising:
based on track class information corresponding to the fusion P-Box, readjusting an adjusted length of the fitting rectangular shape and an adjusted width of the fitting rectangular shape.

17. The method of claim 16, wherein the readjusting of the adjusted length of the fitting rectangular shape and the adjusted width of the fitting rectangular shape comprises:
determining, based on the track class information, minimum and maximum values of length and width of the fitting rectangular shape, and
determining the adjusted length and the adjusted width within a range between the minimum and maximum values of length and width.

18. A vehicle comprising:
a first sensor;
a second sensor;
a driving control circuit configured to control autonomous driving of the vehicle;
a processor; and
a memory storing at least one instruction that, when executed by the processor communicating with the memory, is configured to cause the vehicle to:
obtain, from the first sensor and the second sensor, shape information and heading angle information for an object in a surrounding environment of the vehicle, wherein the shape information comprises at least four vertices positions of the object,
based on the shape information and the heading angle information from the first sensor, generate a reference predicted bounding box (P-Box),
based on the shape information and the heading angle information from the second sensor, generate at least one second P-Box,
select, based on similarity to the reference P-Box, an alignment target P-Box from among the at least one second P-Box,
based on vertex positions of the reference P-Box, adjust vertex positions of the alignment target P-Box,
based on the reference P-Box and the alignment target P-Box with the adjusted vertex positions, generate a fusion P-Box,
generate a fitting shape corresponding to the object in the surrounding environment of the vehicle by refining the fusion P-Box based on at least one of a size, heading of the fusion P-Box, or object class information,
output a signal indicating the fitting shape, and
control, via the driving control circuit and based on the signal, autonomous driving of the vehicle.

19. The vehicle of claim 18, wherein the at least one instruction, when executed by the processor communicating with the memory, is configured to cause the vehicle to determine each vertex of the fusion P-Box by selecting a point between a corresponding vertex of the reference P-Box and a corresponding vertex of the alignment target P-Box, based on a weight assigned to each of the reference P-Box and the alignment target P-Box.

20. The vehicle of claim 18, wherein the at least one instruction, when executed by the processor communicating with the memory, is configured to cause the vehicle to determine a heading of the fitting shape by:
identifying, as a reference side, a side of the fusion P-Box that is closest to the first and second sensors and least affected by occlusion,
identifying, as an opposite side, a side of the fusion P-Box positioned opposite to the reference side, and
determining the heading as a vector perpendicular to the reference side and extending from the reference side toward the opposite side.
